(19) United States
(12) Patent Application Publication
(10) Pub. No.: US 2013/0161259 A1
(43) Pub. Date: Jun. 27, 2013

(54) Method for Continuously Breaking a Water-In-Oil Emulsion and Corresponding Device

(71) Applicant: General Electric Company, Schenectady, NY (US)

(72) Inventor: Michel Moliere, Belfort (FR)

(73) Assignee: GENERAL ELECTRIC COMPANY, Schenectady, NY (US)

(21) Appl. No.: 13/719,776

(22) Filed: Dec. 19, 2012

(30) Foreign Application Priority Data
Dec. 21, 2011 (FR) 11 62218

(51) Int. Cl. B01D 17/04

(52) U.S. Cl. CPC B01D 17/042
USPC 210/665; 210/708; 210/177

(57) ABSTRACT

A device and method for continuously breaking an initial emulsion of the water-in-oil type includes a first step of mixing the initial emulsion with a superheated washing water so as to obtain an intermediate emulsion of the water-in-oil type that comprises a hydrophilic phase and a hydrophobic phase, and that has a number-average diameter of the droplets less than or equal to 50 μm, and a temperature above 100° C. and below the boiling point of the hydrophilic phase at the pressure of the intermediate emulsion. A second step includes destruction of the intermediate emulsion by a liquid-liquid separator so as to obtain a separated hydrophilic phase and a separated hydrophobic phase.

### FIELD OF THE INVENTION

The present invention generally involves a method for breaking emulsions of the water-in-oil type (“W/O” emulsions as opposed to oil-in-water emulsions, “O/W”). It notably relates to the breaking of emulsions of water in a liquid fuel (of fossil or vegetable origin), and more particularly of emulsions of water in a crude oil or a heavy fuel oil.

### BACKGROUND OF THE INVENTION

In the terminology relating to emulsions, the term “oil” denotes a hydrophobic phase, in particular an organic phase immiscible with water. Nouns associated with the action of breaking an emulsion, synonyms of which are “separate”, “destroy”, “break” or “resolve”, are “separation”, “destruction”, “resolution” or “breaking.” For convenience, a water-in-oil (W/O) emulsion can be designated by the term “hydrophobic phase” in cases when the hydrophobic phase is very predominant relative to the hydrophilic phase.

Petroleum fuels often contain small amounts of emulsified water which contain, in the form of dissolved salts, traces of undesirable metals such as sodium, potassium, and calcium. Hereinafter, the salt-laden water will be called “initial hydrophilic phase” or “hydrophilic phase of the initial emulsion,” and the corresponding W/O emulsion “initial emulsion” or “contaminated fuel.” These emulsions are often troublesome in energy applications employing liquid fuels. In particular, the ash formed during combustion of fuels contaminated in this way can cause severe corrosion effects at high temperature within the combustion equipment in question. It is therefore necessary to submit them to “desalting,” i.e., purification upstream of the combustion equipment, in order to remove these metallic traces. Some petroleum fuels can also contain mineral particles in suspension, which may consist of metal salts, oxides, or hydroxides, more or less hydrated. These particles are present in particular in heavy fuel oils because of the deep thermal and catalytic treatments that they underwent in the refinery. On the one hand, the hydrophilic phase that they contained initially has been completely or partially vaporized, leaving crystallites of salts that are more or less hydrated (or even deliquescent) and constituted essentially of sulphates, most often of calcium sulphate, which is poorly soluble in water. Moreover, catalysts in the refining units, such as the FCC (Fluid Catalytic Cracking) units, can also release particles of oxides and of hydroxides, more or less hydrated, of aluminum, silicon, iron, vanadium, nickel, etc. These particles can create problems of fouling, abrasion, or erosion within the combustion equipment.

The conventional method of purification, called “water washing process,” comprises two main steps. The first step is an extraction step in which water, called “washing water” having a low or zero content of minerals, is added to the fuel. Dispersion of the washing water in the fuel leads to the formation of an “intermediate emulsion” in which the droplets of washing water, as they move within the hydrophobic phase, intercept the droplets of the initial hydrophilic phase, with which they coalesce. It is important to note that the coalescence process really only takes place if it is accompanied by a reduction in the surface energy of all of the droplets of the initial hydrophilic phase and of the washing water. This assumes that the initial emulsion is not stabilized by a film of surfactant (or of several surfactants) adsorbed on the periphery of the droplets of the initial hydrophilic phase. This surfactant, which will be called “interfering surfactant,” can either be of natural origin (salts of naphthenic acids contained in petroleum crudes) or of artificial origin (alkali-metal or alkaline-earth metal salts of fatty acids formed for example during the refining treatments). The salts of the initial hydrophilic phase are transferred, after coalescence, to the washing water, which becomes enriched simultaneously with the initial hydrophilic phase, and the droplets of the hydrophilic phase, being larger, are easier to separate from the hydrophobic phase.

The second step is a separation step in which the intermediate emulsion is separated by a physical method, which can be a simple decanting, electrostatic separation, or separation by centrifugation or by coalescence.

A supplementary step of decontamination of the hydrophilic phase after separation may be added to these two steps to meet environmental requirements. In fact, during the separation step, a variable amount of hydrocarbons (and more generally organic compounds) migrates from the hydrophobic phase to the hydrophilic phase, and is entrained, in dissolved form or as O/W emulsion, with said separated hydrophilic phase.

The purification efficiency is defined as the difference in concentrations of the contaminant in question, within the oil or hydrophobic phase, before and after washing with water, said difference being divided by the concentration of the same contaminant before washing.

This treatment has two main limitations. First, the intermediate emulsion that is created during the extraction stage must not be too fine, otherwise the separation step may be compromised and the purification efficiency may be impaired. Second, when the initial emulsion is very fine (with droplet sizes possibly of just a few microns) and/or when it contains an interfering surfactant, the purification efficiency may prove to be inadequate and sometimes close to zero. In this case these will simply be called “difficult” (initial) emulsions.

The first limitation means that the action of mixing of the washing water in the hydrophobic phase, during the extraction step, should take place with a limited level of turbulence, i.e., with a moderate input of mechanical energy to avoid the formation of an emulsion that is too fine and to ensure complete and easy resolution of the intermediate emulsion. As a guide, the droplet size is preferably a few hundred microns. This rules out the use of high-performance mixing devices, such as the high-turbulence dispersers described later.

The second limitation, associated with “difficult emulsions”, is overcome in several ways. One way is by increasing the amount of washing water used in order to increase the probability of capture of the droplets of the initial hydrophilic phase by the droplets of washing water, which increases the operating cost of the treatment and the volume of the hydrophilic phase separated that has to be treated in the decontamination step. Another way is by installing several washing stages in series, which increases the capital cost for this treatment. Another way is by the “chemical route,” which consists of using one or more “demulsifier(s).”

In general, a “demulsifier” or “emulsion breaker” is a substance which, when added in limited concentration (some tens of ppm) to the continuous phase, promotes the process of coalescence between the droplets of the emulsified phase. According to Bancroft's rule, a surfactant that is able to promote oil-in-water (“O/W”) emulsions is also able to break W/O emulsions. Such an additive, which therefore plays the role of demulsifier for W/O emulsions, must moreover be dissolved in the hydrophobic phase. However, besides the additional operating costs connected with this treatment, it should be noted that an effective demulsifier is selected and its optimum dosage is determined on an essentially empirical basis and that it is necessary to test a certain number of demulsifiers, at different concentrations, with the particular fuel to be treated. In these conditions, it often happens that even a limited change in the characteristics of the fuel necessitates altering the dosage or even changing the demulsifier. Now, more and more often fuels are supplied on “spot markets,” so that it has become impossible in practice to control their origin and predict their quality. Monitoring of the demulsifying treatment, as the deliveries of fuel oil are made, has therefore become necessary. Moreover, if the dosage of demulsifier has to be increased to destroy a difficult W/O emulsion, there is a risk of causing inversion of the emulsion and of promoting, during the water washing, an emulsion of the 0/W type, which is undesirable as it complicates the step of decontamination of the separated hydrophilic phase. It is therefore clear that there is a relatively limited margin of maneuver to get rid of difficult emulsions by the “chemical route.”

Faced with these drawbacks and limitations of the conventional chemical treatments, methods employing a thermal route, which are of relatively simple and inexpensive application, offer an interesting alternative. Resolution of emulsions by the thermal route consists of heating the initial emulsion to a high temperature that can lead to a “pre-resolved” liquid-liquid mixture or “pre-resolved emulsion,” i.e., an emulsion that is not yet separated completely but in which the hydrophilic phase is present in the form of large droplets or even of macroscopic aqueous pockets which are admittedly suspended in the hydrophobic phase but whose complete separation has become easy. This “pre-resolved liquid-liquid mixture is then separated completely using suitable equipment, such as a decanter, a centrifugal separator, etc.

The prior art contains several methods of destroying emulsions based on water and oil employing the thermal route. U.S. Pat. No. 4,938,876 to Ohsol discloses a thermal method of breaking emulsions based on water and oil, optionally laden with solid particles, which comprises three main steps: (1) heating, under pressure, the mixture of oil and hot water and/or steam; (2) cooling said mixture below 100° C. by a step with a rapid drop in pressure, during said step a fraction of the water and a light fraction (“light ends”) of the oil being vaporized; and (3) separating the water from the oil in the mixture (if necessary after any solids present have been removed from the mixture). The subsequent U.S. Pat. No. 5,738,762, of the same inventor, supplements the first method by disclosing a method of separating the liquid-liquid mixture containing the aqueous and hydrocarbon fractions that were not vaporized in step 2. The method of separation remains the same as in U.S. Pat. No. 4,938,876.

PCT patent WO 2010/041080 A1 to Fenton consists of passing the W/O emulsion through a nozzle in which the working fluid can be steam or a compressed gas and separating the two phases of the emulsion thus pre-resolved.

However, the methods presented above have the main drawback that the liquid portion of the system obtained after the thermal treatment is accompanied by a vapor phase, separation of which is necessary because if it remained it would induce hydraulic operating problems in the downstream section of the circuit (poor flow through accumulation of vapor at the high points; incorrect control and measurement of flow rate; cavitation in pumps; etc.). In examples 1 and 2 (batch process) in U.S. Pat. No. 4,938,876, the vapor is separated by venting the autoclave atmosphere. In example 3 of the same document and in U.S. Pat. No. 5,738,762 (continuous processes), the pressurized chamber, in which the water-oil mixture circulates, is vented.

In PCT patent WO 2010/041080 A1, the vapor used is, according to claim 14, separated after the operation of partial vaporization of the emulsion.

Thus, to perform liquid-liquid separation and obtain vapor-free hydrophobic and hydrophilic phases, it is in fact necessary to add a step of separation of the gaseous phase, said step being added to the steps already envisaged in the cited documents. Now, although the separation of water and vapor represents a minor operation in the case of a laboratory set-up or a pilot-plant installation, as is the case in the descriptions of the patents of Ohsol and of Fenton, it is not the same in industrial installations. In fact, even though such a separation operation presents no physical difficulty in view of the large density difference between vapor and liquid, it requires continuous—and therefore automatic—control of the level of the liquid-vapor interphase in the vessel where it is carried out. This level could not be left “floating” because on the one hand a level that is too high could cause liquid (therefore oil) to go back into the vapor extraction line and, on the other hand, a level that is too low could cause vapor to pass into the line for withdrawal of the liquid with, in consequence, the drawbacks mentioned above regarding the manipulation of two-phase flows. Said control of the interphase level can be achieved, for example, by acting upon the aperture of the valve through which the separated vapor is removed from the vessel, which requires a sensor for detecting the liquid level, an actuator of the valve for withdrawing vapor and a control loop between these two elements. It can therefore be seen that this separation operation constitutes, per se, an inescapable step of the treatment in an industrial continuous operating mode.

Moreover, in energy terms, it is difficult to utilize the low-pressure vapor thus separated, which is moreover most often contaminated with vapors of hydrocarbons or VOCs (volatile organic compounds) and is therefore lost and must undergo VOC decontamination before being vented, to meet safety or environmental requirements.

In view of the prior art, it is therefore desirable to provide a method for breaking water-in-oil emulsions, which is preferably continuous, and requires a smaller number of steps, resulting in an installation that is less expensive, and that preferably consumes less energy.

### BRIEF DESCRIPTION OF THE INVENTION

Aspects and advantages of the invention are set forth below in the following description, or may be obvious from the description, or may be learned through practice of the invention.

The applicant has now discovered that it is possible to resolve a difficult initial W/O emulsion by a simpler thermal method, employing a water washing treatment. In particular, on the one hand the washing water is used in the superheated state in order to create thermal shock on the initial emulsion and on the other hand it is introduced into the latter with very strong agitation so as to create, between the washing water and the hydrophobic phase, an intermediate W/O emulsion, which is very fine but which breaks spontaneously at the temperature of the thermal shock. This observation was initially made on samples of difficult emulsions from industrial cases and was then verified on artificial W/O emulsions deliberately made very “difficult” by adding surfactants of the “W/O emulsifier” type. The intermediate emulsions were produced by means of a laboratory mixer of the rotary type, with variable speed and with “high shear rate” (Ultra-Turrax® commercial apparatus).

Hereinafter, the average diameters of the droplets are defined as the number-average (arithmetic mean of the diameters of a population of droplets).

According to one aspect, a method is proposed for continuously breaking an initial emulsion of the water-in-oil type. A first step comprises, or consists of, mixing the initial emulsion with a superheated washing water so as to obtain an intermediate emulsion of the water-in-oil type that comprises a hydrophilic phase and a hydrophobic phase, and that has a number-average diameter of the droplets less than or equal to 50 μm and a temperature above 100° C. and below the boiling point of the hydrophilic phase at the pressure of the intermediate emulsion. A second step comprises, or consists of, destruction of the intermediate emulsion by a liquid-liquid separator, preferably of the electrostatic or centrifugal type, so as to obtain a separated hydrophilic phase and a separated hydrophobic phase.

The method thus described makes it possible to limit the number of steps of destruction of W/O emulsions to two, makes it possible to obtain a high purification efficiency owing to the small droplet size of the washing water injected into the hydrophobic phase, whose probability of collision with the initial water droplets is thus increased, and avoids the formation of a gaseous phase.

The applicant has developed a method of breaking W/O emulsions by the thermal route carried out continuously on the line conveying said emulsion, comprising only two steps and not generating vapor phase contaminated with VOCs. For this, this method combines, in a first step, on the one hand, a thermal shock treatment performed with superheated washing water and bringing the hydrophobic phase to a temperature above 100° C., and on the other hand, an effect of liquid-liquid mixing with high efficiency. The application of said liquid-liquid mixing of high efficiency seems paradoxical considering the objective of separating the two phases, in so far as execution of said intensive mixing should, according to the prior art, oppose correct destruction of the emulsion.

It will be recalled that superheated water is water in the liquid state having a temperature above its boiling point at atmospheric pressure, i.e., above 100° C. In a temperature-pressure diagram (with the temperature on the abscissa and the pressure on the ordinate), the point representing superheated water is situated above the liquid-vapor equilibrium curve and to the right of the point (100° C., 1 atm).

The method can also comprise a step of preheating of the washing water before mixing with the initial emulsion, said preheating step comprising recovery of the heat of the separated hydrophilic phase. Such a step does not participate directly in the separation of the hydrophilic phase and the hydrophobic phase of the intermediate emulsion, but makes it possible to limit the energy consumption of the method.

The method can also comprise a decontamination step in which the separated hydrophilic phase is circulated over a bed of activated charcoal. In this way the organic compounds entrained with the separated hydrophilic phase are removed. Furthermore, there is no gaseous effluent requiring treatment.

The initial emulsion and the separated hydrophobic phase comprise mineral particles in suspension and the concentration of mineral particles in the separated hydrophobic phase is less than the concentration of mineral particles in the initial emulsion. The concentration of mineral particles in the separated hydrophobic phase is thus reduced appreciably by destruction of the emulsion.

According to another aspect, a device is proposed for in-line destruction of an initial emulsion of the water-in-oil type, comprising, or consisting of: a heating means supplied with washing water and able to supply superheated washing water; a mixing means, notably rotary with a high shear rate, mounted in line on a line conveying the initial emulsion and fed with superheated washing water supplied by the heating means, the mixing means being able to form an intermediate emulsion of the water-in-oil type that comprises a hydrophilic phase and a hydrophobic phase and that has a number-average diameter of the droplets less than or equal to 50 μm and a temperature above 100° C. and below the boiling point of the hydrophilic phase at the pressure of the intermediate emulsion; and a liquid-liquid separator, preferably of the electrostatic or centrifugal type, installed downstream of the mixing means and able to supply, from the intermediate emulsion, a separated hydrophilic phase and a separated hydrophobic phase.

Preferably, the heating means comprises a heat exchanger fed on the one hand with the separated hydrophilic phase as hot source and on the other hand with the washing water as cold source that has to be superheated or with the initial emulsion.

Preferably, the device also comprises a bed of activated charcoal installed downstream of the liquid-liquid separator, on a line for removing the separated hydrophilic phase.

Other advantages and characteristics of the invention will become clear on examining the detailed description of one embodiment of the invention, which is not in any way limiting, and the single appended drawing, showing, schematically, an emulsion breaking device according to the invention.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is an emulsion breaking device according to the invention.

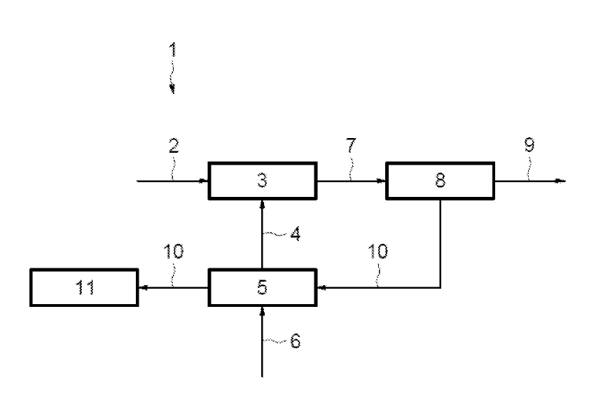

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream,” “downstream,” “radially,” and “axially” refer to the relative direction with respect to fluid flow in a fluid pathway. For example, “upstream” refers to the direction from which the fluid flows, and “downstream” refers to the direction to which the fluid flows. Similarly, “radially” refers to the relative direction substantially perpendicular to the fluid flow, and “axially” refers to the relative direction substantially parallel to the fluid flow.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The single drawing shows, schematically, a device 1 for breaking an initial emulsion. The device 1 comprises a conveying line 2, for example a conveying line in which a liquid fuel, for example a petroleum-based liquid fuel, circulates continuously. The petroleum-based liquid fuel forms an initial emulsion and comprises an initial hydrophilic phase that we wish to separate from the hydrophobic phase.

The device 1 comprises a mixing means 3, mounted on the conveying line 2 and supplied with the initial emulsion. The mixing means 3 also receives superheated washing water (i.e., water in the liquid state and having a temperature above 100° C.) via a pipe 4. The washing water is superheated beforehand by a heating means 5 fed with water via a pipe 6.

In order to remain vapor-free, the superheated water is maintained at an absolute pressure strictly above its saturated vapor pressure Pᵥ, which depends on the temperature. Dupré's empirical formula gives, in the temperature range covered by the present invention, the relation between the boiling point T_{bp} and the saturated vapor pressure Pᵥ, as follows:

Pᵥ˜(T_{bp}/100)4 or: T_{bp}˜100Pᵥ(0.25) (1)

where the temperature T_{bp} is in degrees Celsius and the pressure Pᵥ is in atmospheres.

For mixing in line, the thermal shock is necessarily effected in isobaric conditions, at absolute pressure, or “Po,” that prevails within the pipework conveying the hydrophobic phase. This requires: that the superheated water used is available at a pressure above Pₒ for it to be able to be injected into said pipework, which is the case in practice; that the initial enthalpy (before injection) of the superheated water is sufficient for the mixture to exceed 100° C. during thermal shock; and that this initial enthalpy does not exceed the limit value, above which the temperature of thermal shock (T*) would exceed the boiling point (T_{bp}) of the water at this pressure Pₒ, to avoid the formation of pockets of vapor after injection.

Using Dupré's relation (1) given above, the last two conditions are written:

T*<100Pₒ(0.25). (2)

Using Tₒ₁ and T_{w1} to denote respectively the initial temperature of the initial emulsion and of the superheated washing water, Cₚₒ and C_{pw} to denote their respective mass-based heat capacities, γ denotes the ratio (Cₚₒ/C_{pw}), X_{w} fraction by weight of superheated washing water injected (that of the hydrophobic phase having the value (1-X_{w}), the thermal balance of the thermal shock is then written:

X_{w}C_{pw}(T*−T_{w1})=(1−X_{w})Cₚₒ(Tₒ₁−T*)

That is:

X_{w}(T*−T_{w1})=γ(1−X_{w})(Tₒ₁−T*) (3)

This gives the value of the temperature reached during thermal shock:

T*=[X_{w}T_{w1}+γ(1−X_{w})Tₒ₁]/[X_{w}+γ(1−X_{w})]. (4)

It can also be deduced from equations (2) and (4) that for T* to exceed 100° C. but not exceed the boiling point T_{bp} at the pressure Pₒ, the fraction by weight X_{w} of superheated water satisfies the double inequality:

γ(Tₒ₁−100)/(100−T_{w1})+γ(Tₒ₁−100)<X_{w} (5)

X_{w}<γ(Tₒ₁−100Pₒ0.25)/(100Pₒ0.25−T_{w1})+γ(Tₒ₁−100Pₒ0.25).

For approximate calculations, we can take C_{pw}=4.2 kJ/kg, Cₚₒ=2 kJ/kg i.e., γ=0.476.

It should be noted that the energy balance of the thermal shock expressed by equation (5) should in principle include the physical energy of pressure contained in the superheated water, which, as is discussed later, is first released in the form of kinetic energy during injection of the superheated water into the initial emulsion, then is dissipated, finally, in the form of heat energy in the mixture. This input of pressure energy leads to an increase in the temperature of thermal shock equal to [(Pₑ₁−Pₒ)/(ρ_{w}*C_{pwo})] where ρ_{w} is the density of the superheated water and C_{pwo} is the mass-based heat capacity of the intermediate W/O emulsion. However, this effect does not exceed a few tenths of degrees and can therefore be neglected.

Thus, the amount of washing water supplied by the heating means makes it possible to obtain a fraction by weight X_{w} in the intermediate emulsion satisfying the double inequality (5).

The mixing means 3 is preferably a rotary mixer with a high shear rate. It notably makes it possible to form, in a single pass, an intermediate emulsion with droplets having a number-average diameter less than or equal to 50 μm. The intermediate emulsion is then conveyed via a pipe 7 to a liquid-liquid separator 8, for example a decanting separator, or preferably an electrostatic or centrifugal separator. The separator 8 then delivers on the one hand a separated hydrophobic phase, which is withdrawn via a pipe 9, and on the other hand a separated hydrophilic phase, which may be contaminated with organic compounds and which is withdrawn via a pipeline 10.

Advantageously, the heating means 5 comprises a heat exchanger (or heat exchanger-economizer) mounted on a pipeline 10 and in which the hot source is the separated hydrophilic phase, which preheats the washing water that has to be superheated.

Moreover, the device 1 can also comprise a decontaminating means 11 of the separated hydrophilic phase, for example a bed of activated charcoal 11, mounted on pipeline 10. The decontaminating means 11 makes it possible to remove the organic compounds contained in the separated hydrophilic phase.

The rapid incorporation of superheated water in the initial emulsion is equivalent to “thermal shock,” i.e., a sudden and substantial increase in temperature. The temperature T* of the intermediate emulsion is thus above 100° C. For the treatment to have the character of thermal shock, i.e., to cause a sufficiently high and sudden temperature rise in the whole volume of the initial emulsion, two conditions must be fulfilled. On the one hand it is necessary that the superheated water supplies a sufficient quantity of heat, said quantity depending on its initial temperature and on its fraction by weight X_{w}. On the other hand it is necessary that the mixing of the superheated water and initial emulsion is rapid and uniform, i.e., affects all of the initial emulsion simultaneously. These two conditions are fulfilled by installing, on line 2, a mixer 3 with a high shear rate, having the characteristics stated below.

It will be noted that the physical energy of pressure contained in the superheated water and which is transferred in the form of kinetic energy to the initial emulsion at the moment of injection-expansion of the superheated water, also contributes to the mixing process. However, experience shows that on the one hand this energy is insufficient to ensure that a dispersion is obtained that is sufficiently fine and homogeneous and on the other hand it is largely lost in the form of heat energy under the effect of the forces of friction (viscous forces) encountered by the droplets of superheated water injected into the initial emulsion. This pressure energy is therefore finally dissipated in the form of thermal energy.

The superheated water thus has a dual role. During thermal shock, it plays the role of “thermal fluid” which notably has the effect of causing desorption of the interfering surfactants from the initial water droplets and of thus neutralizing their emulsion stabilizing effect. In other words, the large and sudden increase in temperature at every point of the hydrophobic phase weakens the interfaces of the droplets of the initial hydrophilic phase, both as a result of rapid expansion of these droplets (physical effect) and of thermal desorption of any “interfering surfactants” (chemical effect) that might have been concentrated in the van der Waals layer prior to the emulsion breaking process. This makes coalescence possible between droplets of the initial hydrophilic phase and of the superheated washing water.

It also serves as washing water, i.e., as phase capable of capturing the droplets of the initial hydrophilic phase and of transforming the initial emulsion into a pre-resolved emulsion. This process by which the droplets of washing water capture and fuse with the droplets of the initial hydrophilic phase is similar to that described for the conventional method of washing fuels with water, but with very important differences in terms of intensity. In fact, the efficiency of washing is greatly increased by the combination of the effects of strong turbulence imposed by intensive agitation, the small sizes of the droplets of washing water and the high temperature, effects which reinforce the transport processes (decrease in viscosity of the hydrophobic phase; increase in rates of diffusion and of internal Brownian motion) and the probability of collisions between the droplets of the initial hydrophilic phase and the droplets of washing water.

In order to achieve rapid and uniform mixing of the superheated water and initial emulsion, a “high-performance mixer” 3, such as the mixers with high shear rate defined later, can be used. Said mixers 3 generate a very fine distribution of sizes of droplets of washing water, to maximize their contact with the initial emulsion. The treatment is carried out “on line.” The mixer 3 with high shear rate is mounted on the pipework for circulation of the hydrophobic phase (or initial emulsion), at the very point where the superheated washing water is injected into the initial emulsion, and mixes the entire flow (initial phase+superheated washing water) in a single pass, i.e., without recirculation. Among the high-performance mixers 3, rotary mixers with a high shear rate of the phases are found to have extremely good performance. In mixers of this type, represented for example by the “Dispax-Reactor®” devices, which are the industrial equivalents of the “Ultra-Turrax®” laboratory devices, the two phases are introduced between two coaxial cylindrical rings, optionally ribbed longitudinally, and rotating at high speeds in opposite directions or else with one fixed and the other rotating at very high speed. The turbulence energy thus imparted to the two phases by the shear stress field created in the space between the two rings is transformed with excellent efficiency into interfacial energy, which permits dispersion of the hydrophilic phase (the superheated washing water) in the form of very fine droplets (average size from a few microns to a few hundred microns depending on the energy imparted). These rotary mixers with a high shear rate of the phases, for which there are commercial models covering a wide range of flow rates, are driven by electric motors equipped with variable speeds, permitting easy adjustment of the energy imparted to the system. For example, for a utilizable mechanical energy of 0.7 kJ/dm³, the average droplet size with the “Dispax-Reactor®” devices is of the order of 50 μm. For a useful energy of 15 kJ/dm³, it is of the order of 10 μm. The high-performance mixers required in the context of the present invention are those making it possible to achieve an average droplet size of max. 50 μm. It will be noted that these high-performance mixers, which operate at high speed, could not be used in the presence of vapor phase as they generate severe cavitation effects which would cause premature wear or even destruction of the mixer. It will also be noted that these dispersions, characterized by an average droplet size less than or equal to 50 μm, could be very difficult to obtain with static mixers and at the cost of excessive pressure losses and at the risk of phenomena of erosion of the components and walls in contact with the liquid. Another advantage of rotary mixers with a high shear rate is precisely that they do not cause pressure loss on the line but on the contrary create a slight driving effect on the main fluid which, in the present case, is the hydrophobic phase to be purified.

It should be emphasized that the fine droplet size of the superheated washing water used during the heat treatment phase does not adversely affect the subsequent separation step. This is the opposite of what happens in the conventional methods of washing, as was pointed out above. Thus, examination of the prior art does not suggest trying to create such fine intermediate emulsions. This unexpected feature can be explained by the combination of thermal effects and intensive mixing as described above, the intermediate emulsion being very fine but of a physical nature and therefore not stabilized by a surfactant.

After the thermal shock, i.e., downstream of mixer 3, the two-phase system obtained consists of the combination of the hydrophobic phase and of a hydrophilic liquid phase which is itself the combination of the initial hydrophilic phase and of the washing water and is present in the form of droplets with fairly large diameters owing to processes of coalescence, in the absence of any phase of residual steam. In continuous conditions, owing to the turbulent circulation of this two-phase system, a coarse dispersion of the hydrophilic phase in the hydrophobic phase may persist, downstream of the mixer, but this dispersion is infinitely less stable than the initial emulsion and can easily be separated into two pure phases, using a suitable separator, as described below.

As the mixture leaving mixer 3 is vapor-free and its temperature can only decrease downstream of the mixer in the absence of external heating, no pocket of steam can appear in the subsequent course of the process.

The applicant's research indicates that application of this method of thermal shock to the superheated washing water comprising only two steps, in addition to its efficiency and its simplicity, has three other strong points. It not only makes it possible to break even difficult water-in-oil emulsions, but also to separate any mineral particles that may be present in suspension, these hydrophilic particles being captured by the droplets of washing water under the effect of capillary forces. This method with superheated water lends itself to energy savings, as it is possible to install a heat exchanger-economizer in which the cold fluid is the washing water before it is superheated and the hot source is the separated hydrophilic phase. This can provide a substantial energy saving. It will be noted that the application of this heat recovery is only beneficial because, as the thermal fluid is permanently below its boiling point, no vapor phase appears. It is possible to use a very simple liquid-liquid heat exchanger (tubular exchanger or plate-type exchanger) in the absence of liquid-gas interphase. Heat exchange in which the hot fluid is steam or a steam/hot water mixture would require a more complex design of exchanger because of the need to “manage” the water/steam mixture resulting from exchange. This method does not generate a stream of vapor contaminated with VOCs but a stream of liquid water, admittedly potentially laden with organic compounds but which can easily be purified simply by being passed over a bed of activated charcoal after cooling to a temperature compatible with the operation of absorption on said bed of activated charcoal. Other substances such as for example particles of vegetable biomass activated by the thermal route can be used for this purpose, in place of activated charcoal.

To illustrate the invention, three examples of execution are described below.

### 1st Example

An oil consisting of a very heavy petroleum-based fuel oil having a density of 0.980 kg/dm³ and a viscosity of 380 cSt (centistokes) at 50° C. is contaminated both with an emulsified aqueous phase rich in sodium and potassium sulphates and with a fine suspension of particles of calcium sulphate. Thus, it contains 53 mg/kg of (sodium+potassium) and 45 mg/kg of calcium.

This oil, which is intended as feed for an industrial gas turbine of 400 MW of thermal power, is withdrawn from its storage tank at T_{f}=50° C.

It is decided to submit it to a thermal shock treatment with superheated water, in the absence of demulsifier, and combined with water/fuel oil separation by means of an electrostatic separator.

Washing water superheated to a temperature of 250° C. is used, at an absolute pressure of 41 bar (or 39.5 atm. gauge), which is prepared from pure water at 25° C. The oil circulates at a flow rate of 30 t/h in pipework in which the pressure is 4 bar gauge, or an absolute pressure of 4.9 atm. A stream of water of 25 t/h of this superheated water through a mixer of the Dispax-Reactor® type, the rotary speed of which is set to create a number-average droplet size of the order of 50 μm. The fraction by weight of superheated water is therefore X_{w}=25/(30+25)=0.455. The thermal shock temperature T* is calculated from relation (5): T*=107° C.

The mixture leaves the thermal shock at a temperature of 106° C. and at a pressure of 3.8 bar gauge (4.75 atm. absolute). It will be noted that 106° C. is well below the boiling point of water at 4.75 atm. absolute, which is 148° C. The mixture is then sent to a separator of the electrostatic type which has a treatment capacity of 40 t/h of mixture and whose maximum operating conditions are 150° C. and 10 barg. Therefore it is not necessary to expand or cool the mixture for conveying it to the electrostatic separator.

The electrostatic separator delivers at its outlet, on the one hand the oily phase not containing more than 0.5 mg/kg of (sodium+potassium) and 2.5 mg/kg of calcium and on the other hand an aqueous phase, at a flow rate of about 25.4 t/h, containing about 30 mg/kg of sodium+potassium and 25 mg/kg of calcium. The residual organic contaminants can be removed from this water by passing it, after cooling, over a bed of activated charcoal.

### 2nd Example

The same oil as in example 1 is submitted to a treatment of purification by thermal shock using the same quality of superheated water (250° C., 41 bar gauge). However, this time the washing water circuit is provided, upstream of the superheating device, with an exchanger-economizer, the hot source of which is the washing water at 106° C. that comes from the electrostatic separator and that leaves the economizer at 63° C. The heat saving, which is equal to C_{pw}*(106−63), represents about 20% of the total amount of heat to be supplied for raising the water required for the treatment from 25° C. to its superheated state, the latter amount being C_{pw}*(250−25).

### 3rd Example

A diesel fuel with density of 0.830 kg/dm³, and flash point of 55° C., available at an initial temperature T_{f} of 25° C., is contaminated with a difficult aqueous emulsion (probably owing to the presence of surfactants, of unidentified nature and origin), which creates a sodium content of 1.2 mg/kg and a potassium content of 0.15 mg/kg. It is used as auxiliary fuel for a gas turbine of the “aero-derived” type intended as mechanical drive, the main fuel of which is natural gas and the specification of which requires a total content of alkali metals below 0.2 mg/kg. The purification efficiency required is therefore [(1.2+0.15)−0.2)]/(1.2+0.15) or 85%. The turbine has a mechanical power of 45 MW corresponding to a thermal power of the order of 100 MW and at full load consumes 9 t/h of diesel fuel. However, because of its very limited operation on diesel fuel (load factor with diesel fuel less than 7%), it is sufficient to have a purification unit with a capacity of 9*0.07=0.63 t/h operating continuously.

The diesel fuel circulates at a flow rate of 650 kg/hour in a line at a pressure of 4 bar gauge (about 5 bar absolute).

It is decided to submit it to a thermal shock treatment with superheated water. The separator used is a centrifugal separator.

For this, washing water superheated to 200° C. is used, produced on site, at an effective pressure of 19 bar gauge, corresponding to about 19.7 atm. absolute. This superheated water is injected at a flow rate of 530 kg/hour into the diesel fuel via a rotary mixer with a high shear rate. The fractions by weight of fuel and of vapor before thermal shock are 0.55 and 0.45 respectively; the temperature during thermal shock is 105° C.

This mixture leaves the thermal shock at a temperature of 104° C. The diesel fuel thus treated is passed through a conventional cooler which brings it to 38° C., which is below its flash point, eliminating fire risks. The mixture is then decanted in a centrifugal separator, from which the diesel fuel leaves at less than 0.11 mg/kg of alkali metals (i.e., a purification efficiency of 91%). There is also a stream of about 535 l/h of water which is slightly laden with sodium and potassium and has very little contamination with oil. The residual organic contaminants of this water can also be removed by passing it over a bed of activated charcoal, after it has been passed above the maximum temperature permitted by this last-mentioned treatment.

The consumption of superheated water can again be reduced by about 20% by preheating the washing water to about 63° C. with a heat exchanger using the separated hydrophilic phase at a temperature of 102° C. as the hot source.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for continuously breaking an initial emulsion of the water-in-oil type, comprising:
a. a first step comprising mixing the initial emulsion with a superheated washing water so as to obtain an intermediate emulsion of the water-in-oil type that comprises a hydrophilic phase and a hydrophobic phase, and that has a number-average diameter of the droplets less than or equal to 50 μm and a temperature above 100° C. and below the boiling point of the hydrophilic phase at the pressure of the intermediate emulsion, and
b. a second step comprising destruction of the intermediate emulsion by a liquid-liquid separator so as to obtain a separated hydrophilic phase and a separated hydrophobic phase.

2. The method according to claim 1 in which the first step also comprises a step of heating of the washing water before mixing with the initial emulsion, the superheating step comprising recovery of the heat from the separated hydrophilic phase for preheating the washing water.

3. The method according to claim 1, also comprising a decontamination step in which the separated hydrophilic phase is circulated over a bed of activated charcoal.

4. The method according to claim 1 in which the initial emulsion and the separated hydrophobic phase comprise mineral particles in suspension and in which the concentration of the mineral particles in the separated hydrophobic phase is less than the concentration of mineral particles in the initial emulsion.

5. A device for on-line breaking of an initial emulsion of the water-in-oil type, consisting of:
a. a heating means supplied with washing water and able to supply a superheated washing water;
b. a mixing means, notably rotary with a high shear rate, mounted on line on a conveying line of the initial emulsion and fed with superheated washing water supplied by the heating means, said mixing means being able to form an intermediate emulsion of the water-in-oil type that comprises a hydrophilic phase and a hydrophobic phase, and that has a number-average diameter of the droplets less than or equal to 50 nm and a temperature above 100° C. and below the boiling point of the hydrophilic phase at the pressure of the intermediate emulsion; and
c. a liquid-liquid separator installed downstream of the mixing means and able to supply, from the intermediate emulsion, a separated hydrophilic phase and a separated hydrophobic phase.

6. The device according to claim 5 in which the heating means comprises a heat exchanger supplied with the separated hydrophilic phase as a hot source, and with the washing water as a cold source.

7. The device according to claim 5, also comprising a bed of activated charcoal installed downstream of the liquid-liquid separator on a line for removing the separated hydrophilic phase.
